(19) United States
(12) Patent Application Publication
(10) Pub. No.: US 2015/0054452 A1
(43) Pub. Date: Feb. 26, 2015

(54) System for Wireless Charging Control Based Magnetic Resonance Type

(71) Applicant: Maxwave Co., Ltd., Daejeon (KR)

(72) Inventor: Dong Sik Ahn, Daejeon (KR)

(73) Assignee: Maxwave Co., Ltd., Daejeon (KR)

(21) Appl. No.: 14/288,826

(22) Filed: May 28, 2014

(30) Foreign Application Priority Data
Aug. 22, 2013 (KR) 10-2013-0099822

(51) Int. Cl. H02J 7/02; H02J 7/00

(52) U.S. Cl. CPC H02J 7/025; H02J 7/007; H02J 7/0052
USPC 320/108

(57) ABSTRACT

Provided is a wireless charging control system based on a magnetic resonance type, and more particularly, a wireless charging control system based on a magnetic resonance type which does not require a separate transmitter unit and a receiver unit to detect a current charging state of a receiving charger unit between a power transmitter unit and the receiving charger unit and changes a transmission output of a power transmitter unit in real time by changing a load impedance of a load element coil using a variable capacitor or a switch to meet a charging state of a battery unit by the receiving charger unit to prevent unnecessary transmission power while charging, thereby more efficiently and safely performing wireless charging.

### TECHNICAL FIELD

The following disclosure relates to a wireless charging control system based on a magnetic resonance type, and more particularly, to a wireless charging control system based on a magnetic resonance type which does not require a separate transmitter unit and a receiver unit to detect a current charging state of a receiving charger unit between a power transmitter unit and the receiving charger unit and changes a transmission output of a power transmitter unit in real time by changing a load impedance of a load element coil using a variable capacitor or a switch to meet a charging state of a battery unit by the receiving charger unit to prevent unnecessary transmission power while charging, thereby more efficiently and safely performing wireless charging.

### BACKGROUND

Generally, a battery pack is coupled with various types of portable terminals, such as a mobile telephone, personal digital assistants (PDAs), an MP3 player, digital multimedia broadcasting (DMB), a portable music player (PMP), and the like, so as to supply power to the portable terminals.

A user of the portable terminals charges a battery pack using a charger when a voltage of the battery pack drops to a predetermined level or less and then uses the portable terminals again, and most of the battery packs have connection terminals exposed to the outside so as to be electrically connected to charging terminals which are equipped in the charger and the user performs charging in the state in which the charging terminals of the charger contact the connection terminals of the battery pack to keep an electrical connection state therebetween.

However, since the charging terminal of the charger and the connection terminal of the battery pack are always exposed to the outside, the charging terminal and the connection terminal may be easily polluted by foreign materials and worn while the charger and the battery pack contacts or is separated from each other, and in the humid atmosphere, the charging terminal or the connection terminal may be corroded to make the connection between the connection terminal and the battery pack poor and in the case of the moisture permeation into the battery pack, the lifespan and performance of the battery pack may be reduced.

For this reason, recently, a contactless type charger which charges power in portable devices in a contactless manner has been developed and used.

A charger according to the related art requires a connector for transferring an electrical signal between the charger and the battery pack, but the contactless type charger means a product which does not have contacts between the contactless type charger and the battery pack. Therefore, the contactless type charger wirelessly transmits the electrical signal between the contactless type charger and the battery pack through a coil and therefore a user puts the battery pack on the contactless type charger to perform charging.

That is, the contactless type charger means wirelessly charging the battery pack and the wireless charging type is largely divided into two. One of the wireless charging types is a magnetic induction type and the other of the wireless charging types is a magnetic resonance type.

The magnetic induction type means a type in which a magnetic field flows in a primary coil of a magnetic field radiation coil pad equipped in the contactless type charger to generate a magnetic field and thus an induction current flows in a secondary coil of the battery pack just on the contactless type charger to perform charging. The magnetic induction type may provide wireless charging within a range of several mm to several cm.

Further, the magnetic resonance type means a type which a resonance coil is mounted in the contactless type charger and the battery pack to transmit energy to an apparatus when a resonance frequency of the contactless charger coincides with that of the battery pack and absorb energy as an electromagnetic field when the resonance frequency of the contactless charger does not coincide with that of the battery pack. The magnetic resonance type may provide wireless charging within a range of several m according to an implementation method.

However, to efficiently perform the wireless power transmission using the wireless charging type, there is a need to control the unnecessary power transmission by accurately detecting the current charging state of the battery pack charged by wirelessly receiving charging power from the contactless charger which transmits power.

To this end, the transmitted charging power may be controlled by transmitting the current charging state of the battery pack to the transmitting side, which has a problem in that the contactless charger and the battery pack each need to include separate transmitting and receiving functions.

Further, in the magnetic induction type according to the related art, the impedance of the battery pack is changed and thus a current flow of a transmitting output terminal of the contactless charger is changed. In this case, the contactless charger senses the change to analyze signal information of the battery pack. Therefore, there is a problem in that a modulator forming the transmitting information is additionally required and a demodulator is additionally required to know the received information.

Korean Patent No. 10-0971717 (Wireless Type Charging And Data Communication Control Module For Mobile Terminal and Layout Of The Same) discloses a wireless type charging and data communication control module For mobile terminal and a layout of the same in which a power receiving coil of a charging system and a loop antenna of an electronic approval system are equipped in a battery pack and a cover case of a portable terminal to enable one portable terminal to perform the contactless charging and the electronic approval.

However, according to Korean Patent No. 10-0971717, since the power receiving coil for contactless charging and the loop antenna for the electronic approval system are equipped in one portable terminal, a thickness of the portable terminal is larger and an area of the portable terminal is increased, and therefore a user is inconvenient to carry the portable terminal in spite of the portable terminal.

In addition, the wireless charging chip according to the QI standard used in the typical induction type, which is based on a method for transmitting a state of charge (SOC) information of the battery pack, changes an impedance of a receiver to change a current flow of a transmitting output terminal of a wireless transmitting pad which is a contactless type charger and senses the change current flow to change a communication signal, but the existing wireless charging chip is only unidirectional communication to transmit information on a receiving terminal to a transmitting terminal and may be implemented only in the QI standard chip and may be used only in an induction type from 110 KHz to 250 KHz, and therefore is inconvenient to apply to various structures, various frequencies, various charging types, and the like.

### RELATED ART DOCUMENT

### Patent Document

(Patent Document 1) Korean Patent No. 10-0971717 (Registration Date: Jul. 15, 2010)

### SUMMARY

An embodiment of the present invention is directed to providing a wireless charging control system based on a magnetic resonance type which does not require a separate transmitter unit and a receiver unit to detect a current charging state of a receiving charger unit between a power transmitter unit and the receiving charger unit, changes a transmission output of a power transmitter unit in real time by changing a load impedance of a load element coil using a variable capacitor or a switch to meet a charging state of a battery unit by a receiving charger unit to prevent unnecessary transmission power while charging, and does not require a modulator, a demodulator, and a decoder in order to simply configure a circuit.

In one general aspect, a wireless charging control system based on a magnetic resonance type includes: an oscillator 110 generating power for contactless charging; a transmitting oscillation circuit including a power source coil 120 to which the power is input and a power source capacitor 121 connected to the power source coil 120 in parallel to convert a capacitance so as to cause oscillation at a specific frequency; a power transmitter unit 100 including a transmitting resonance circuit which includes a transmitting resonance coil 130 causing resonance by changing an inductance and a capacitance to be resonated at the same frequency in the transmitting oscillation circuit and a transmitting resonance capacitor 131 connected to the transmitting resonance coil 130 in series; a receiving resonance coil including a receiving resonance coil 210 receiving electromagnetic waves generated by the power transmitter unit 100 and absorbing input energy by being resonated at the same frequency and a receiving resonance capacitor 211 connected to the receiving resonance coil 210 in series; a power receiving circuit including a load element coil 220 to receive power of energy stored in the receiving resonance circuit by changing an impedance and a load element capacitor 221 connected to the load element coil 220 in series; and a receiving charger unit 200 including a controller 230 sensing a strength of current and a charging voltage transferred to a battery unit to change the receiving resonance capacitor 211 or the load element capacitor 221.

The receiving resonance capacitor 211 and the load element capacitor 221 may be configured of a varactor diode.

The impedance of the receiving resonance circuit may be controlled by controlling a voltage of the receiving resonance capacitor 211 of the receiving charger unit 220 or the impedance of the power receiving circuit may be controlled by controlling a voltage of the load element capacitor 221.

A charging current amount supplied from the power transmitter unit 100 may be controlled by changing an input impedance of the power transmitter unit 100 according to the capacitance of the receiving resonance capacitor 211 or the load element capacitor 221.

The controller 230 may be configured of one capacitor and may be connected to the receiving resonance coil 210 and the load element coil 220 in parallel or in series to change the capacitance of the receiving resonance capacitor 211 or the load element capacitor 221.

The controller 230 may be configured of a plurality of capacitors, may be connected to the receiving resonance coil 210 and the load element coil 220 in parallel, in series, and in a combination thereof to change the capacitance of the receiving resonance capacitor 211 or the load element capacitor 221, and may perform a control as a selective switch according to a preset fixed value.

The controller 230 may be configured of an on/off switch and may be connected to the receiving resonance coil 210 or the load element coil 220 to change the capacitance of the receiving resonance capacitor 211 or the load element capacitor 221 and may perform pulse time modulation using the on/off switch to convert the load impedance of the receiving resonance circuit or the power receiving circuit into a value at which a current is transferred well or a value at which a current is not transferred, such that the charging current supplied from the power transmitter unit 100 may be controlled with a pulse width or a pulse frequency.

### BRIEF DESCRIPTION OF THE DRAWINGS

FIG. 1 is a configuration diagram illustrating a general wireless power transmission system.

FIG. 2 is a diagram schematically illustrating a wireless charging control system based on a magnetic resonance type according to an exemplary embodiment of the present invention.

FIG. 3 is a diagram illustrating a basic coupling coil structure of the wireless charging control system based on a magnetic resonance type according to the exemplary embodiment of the present invention.

FIG. 4 is a diagram schematically illustrating the basic coupling coil structure of FIG. 3 for final analysis.

FIGS. 5A to 5C are diagrams illustrating various examples of a controller 230 of the wireless charging control system based on a magnetic resonance type according to the exemplary embodiment of the present invention.

FIGS. 6A and 6B are diagrams illustrating a relationship between a voltage and a current at the time of contactlessly charging using the wireless charging control system based on a magnetic resonance type according to the exemplary embodiment of the present invention.

### DETAILED DESCRIPTION OF MAIN ELEMENTS

100: Power transmitter unit
110: Oscillator
120: Power source coil
121: Power source capacitor
130: Transmitting resonance coil
131: Transmitting resonance capacitor
200: Receiving charger unit
210: Receiving resonance coil
211: Receiving resonance capacitor
220: Load element coil
221: Load element capacitor
230: Controller

### DETAILED DESCRIPTION OF EMBODIMENTS

Hereinafter, a wireless charging control system based on a magnetic resonance type according to an exemplary embodiment of the present invention will be described in detail with reference to the accompanying drawings. The drawings exemplified below are provided by way of examples so that the spirit of the present invention can be sufficiently transmitted to those skilled in the art to which the present invention pertains. Therefore, the prevent invention is not limited to the drawings set forth below, and may be embodied in different forms. Also, like reference numerals denote like elements throughout the specification.

Here, unless indicated otherwise, the terms used in the specification including technical and scientific terms have the same meaning as those that are usually understood by those who skilled in the art to which the present invention pertains, and detailed description of the known functions and constitutions that may obscure the gist of the present invention will be omitted in the specification and the drawings.

As the representative private standardization organization which is promoting international standard of a wireless power transmission field, there is wireless power consortium (WPC). The WPC is an organization which starts as cooperation of companies in Asia, Europe, North America, and the like for the first time in the world and is established to present international standard for compatible wireless charging.

The establishment goal of the WPC is to standardize technical solutions for wirelessly transmitting power for various products to be used in a global market with the commercial needs for wireless power transmission fix a standard which may be compatible between businesses related to power transmission and reception, serve to adopt and publicize a logo for the standard, construct verification, test, and authentication services for developed products, and observe a guide line of the logo.

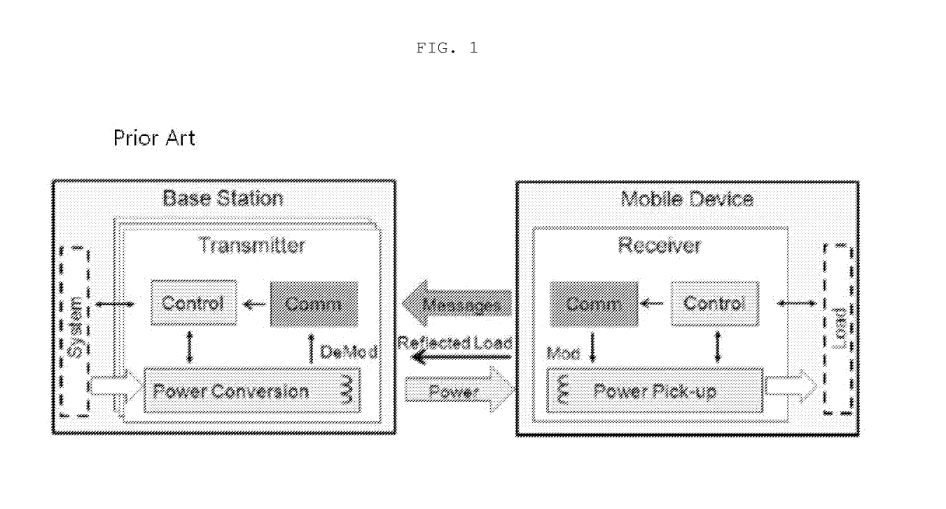

Meanwhile, the WPC is established in October, 2008. FIG. 1 is a diagram schematically illustrating a wireless power transmission system of WPC. Referring to FIG. 1, communication is made between a transmitter unit and a receiver unit for battery management of a charging device and a communication type using a power signal has been adopted.

That is, a power conversion unit converts electricity into a wireless power signal and a power pick-up unit converts the wireless power signal into electricity. The receiver unit transmits control information to a transmitter unit by performing load modulation on the power signal and the transmitter unit receives a message by demodulating a load reflected to receive the control information from the receiver unit and controls a receiver to supply power required for a load.

To control power required for the receiver unit, the receiver unit calculates a difference from actually induced power to transfer an error packet to the transmitter unit and the transmitter unit calculates a current to be newly applied to compensate for an error by measuring an actually applied current so as to determine operating points of parameters to be controlled using an adaptive control algorithm and has a type of applying the determined operating points to the power conversion unit to control the power conversion unit.

In the communication protocol, the receiver unit generally has communication architecture which unilaterally transmits a packet to the transmitter unit and uses a bi-phase type as an encoding type. A communication rate has a transmission rate of 2 Kbps and a structure of the packet is configured of a preamble, a header, a message, and a checksum.

In addition, a wireless power transmission process of WPC includes a selection step of sensing a device, a ping step of receiving a first packet, an ID and configuration step of receiving a unique ID and an extended ID for products and information on a control parameter, and a power transfer step which is a power transmission step.

The wireless charging control system based on a magnetic resonance type according to the exemplary embodiment of the present invention does not include a transmitter unit and a receiver unit for transmitting and receiving current charging state information between a power transmitter unit and a receiving charger unit which is an disadvantage of the related art, changes capacitor capacitance of a tuning circuit connected to a receiver antenna by allowing a receiving charger unit to sense the current charging state to a voltage using a variable capacitor or a switch to change impedance so as to control a charging current from a power transmitter unit, and does not require a modulator, a demodulator, and a decoder in order to simply configure a circuit and have an economic advantage, thereby more safely and effectively controlling the wireless charging.

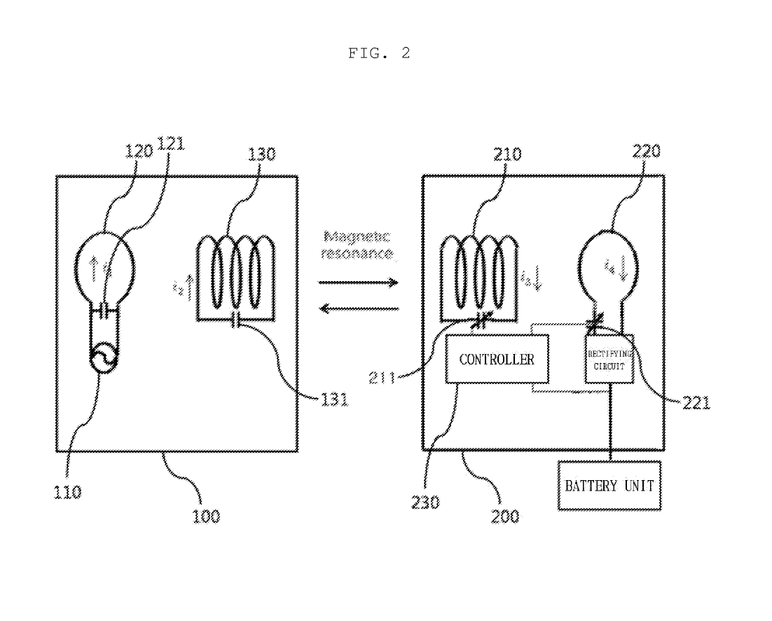

FIG. 2 is a diagram schematically illustrating the wireless charging control system based on a magnetic resonance type according to the exemplary embodiment of the present invention. A configuration of the wireless charging control system based on a magnetic resonance type according to an exemplary embodiment of the present invention will be described in detail with reference to FIG. 2.

The wireless charging control system based on a magnetic resonance type according to an exemplary embodiment of the present invention may be configured to include a power transmitter unit 100, a receiving charger unit 200, and a battery unit (not illustrated) which performs contactless charging due to the receiving charger unit 200.

As illustrated in FIG. 2, the power transmitter unit 100 is configured to include a transmitting oscillation circuit which includes an oscillator 110, a power source coil 120, a power source capacitor (tuning capacitor) 121 connected to the power source coil 120 and a transmitting resonance circuit which includes a transmitting resonance coil 130 and a transmitting resonance capacitor (tuning capacitor) 131 connected to the transmitting resonance coil 130 and the receiving charger unit 200 is configured to include a receiving resonance circuit which includes a receiving resonance coil 210 and a receiving resonance capacitor (variable capacitor) 211 connected to the receiving resonance circuit 210, a power receiving circuit which includes a load element coil 220 and a load element capacitor (variable capacitor) 221 connected to the load element coil 220, and a controller 230.

Describing in detail each component, the oscillator 110 of the power transmitter unit 100 may generate power for contactless charging between the power transmitter unit 100 and the receiving charger unit 200, that is, the power generated from the oscillator 110 may be transferred to the battery unit according to the magnetic resonance type based wireless charging between the power transmitter unit 100 and the receiving charger unit 200.

The transmitting oscillation circuit may change an inductance of the power source coil 120 or a capacitance of the power source capacitor 121 to generate the resonance with the oscillation frequency of the oscillator 110.

Describing in detail, the transmitting oscillation circuit may be configured to include the power source coil 120 to which the power generated from the oscillator 110 is input and a power source capacitor 121 connected to the power source coil 120 in parallel to change the capacitance of the power source coil 120 so as to cause oscillation at a specific frequency.

Similar to the transmitting oscillation circuit, the transmitting resonance circuit changes the inductance of the transmitting resonance coil 130 or the capacitance of the transmitting resonance capacitor 131 to cause the resonance with the oscillation frequency of the oscillator 110.

Describing in detail, the transmitting resonance circuit may be configured to include the transmitting resonance coil 130 which causes resonance by changing an inductance and a capacitance to be resonated at the same frequency in the transmitting oscillation circuit and the transmitting resonance capacitor 131 connected to the transmitting resonance coil 130 in series.

In this configuration, the transmitting resonance circuit may be coupled with the transmitting oscillation circuit to generate electromagnetic waves due to magnetic resonance.

In this case, the inductance (symbol: L, unit: H) changes a magnetic flux penetrating through a coil by a change in current flowing in the coil itself and induces an electromotive force hindering the change in magnetic flux in the coil itself. The phenomenon means magnetic induction which is different according to the turn number of coils, presence and absence of a core, and the like. In other words, the inductance means a nature to temporarily store energy in a magnetic field to resist a flow of alternative current and is generated by an inductor and when the inductance is increased, a time change rate of current is slow and when the turn number of inductors is increased, the inductance is increased.

Further, the capacitance (symbol: C, unit: F) means a charge which is accumulated when potential is applied between insulated conductors, that is, means a nature to temporarily store energy in an electric field to resist a flow of alternative current. The capacitance is generated by a capacitor. Generally, when a capacitance value becomes high, a change rate of voltage is slower and when a voltage between two conductors becomes high, the capacitance is increased.

In addition, the impedance (symbol: Z, unit: Ω) means a ratio of applied voltage in an AC circuit and a current flowing in a circuit and may be generally represented by the following Equation 1.

Impedance Z=V/I=R+jX [Equation 1]

In the above Equation 1, a real part R means resistance and an imaginary part X means reactance.

The receiving resonance circuit of the receiving charger unit 200 may be configured to include the receiving resonance coil 210 and the receiving resonance capacitor 211 which is connected to the receiving resonance coil 210 in series.

The receiving resonance circuit receives the electromagnetic waves generated by the transmitting resonance circuit including the transmitting resonance coil 130 and the receiving resonance capacitor 211 may change the impedance of the receiving resonance circuit to cause the resonance at the same frequency as that of the transmitting resonance circuit.

In this case, the receiving resonance capacitor may be configured of a varactor diode, a capacitor having a fixed value, and a switch, in which the varactor diode may change the capacitance depending on a change in voltage. That is, the varactor diode may control capacitance using an electric signal.

The power receiving circuit may be configured to include the load element coil 220 and the load element capacitor 221 which is connected to the load element coil 220 in series.

The power receiving circuit receives energy stored in the receiving resonance circuit and similar to the receiving resonance circuit, may change the impedance of the load element coil 220 to cause the resonance.

That is, the load element capacitor 221 is connected to the load element coil 220 in series to change the impedance and thus makes a receiving element well receive power at the same frequency as that of the transmitting oscillation circuit.

In addition, similar to the receiving resonance capacitor 211, the load element capacitor 221 may be configured of the varactor diode, the capacitor having a fixed value, or the switch.

The controller 230 may sense a strength of current and a charging voltage, which are transferred to the battery unit, to change the receiving resonance capacitor 211 and the load element capacitor 221.

When using the varactor diode, the controller 230 may control the voltage of the receiving resonance capacitor 211 or the load element capacitor 221 of the receiving charger unit 220 to control the capacitance and when using the capacitor having a fixed value and the switch, the controller 230 may control the switch to control the capacitor.

In this way, according to the controlled capacitance of the receiving resonance circuit or the power receiving circuit, the input impedance of the power transmitter unit 100 may be changed and the charging current amount supplied from the power transmitter unit 100 to the receiving charger unit 200 may be controlled.

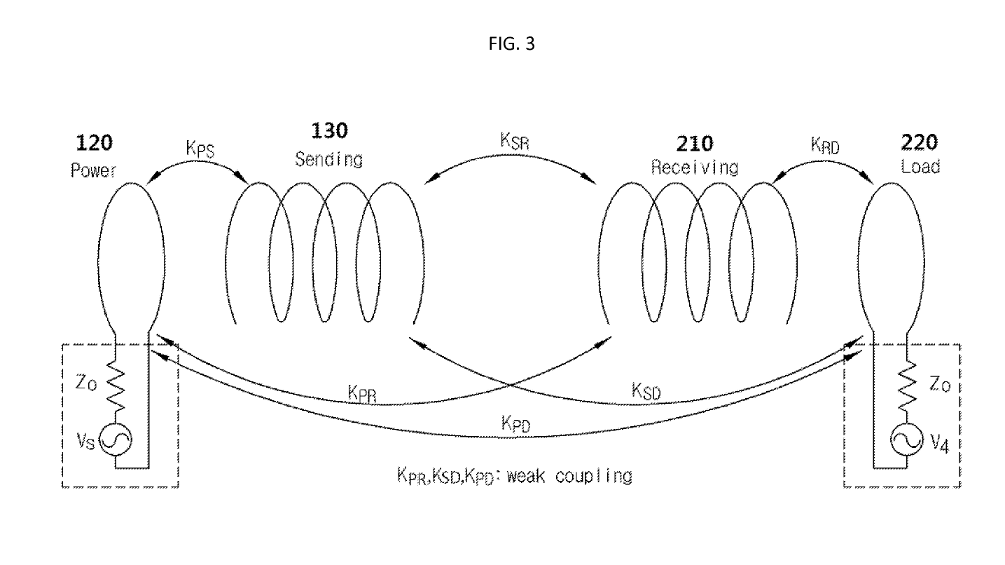

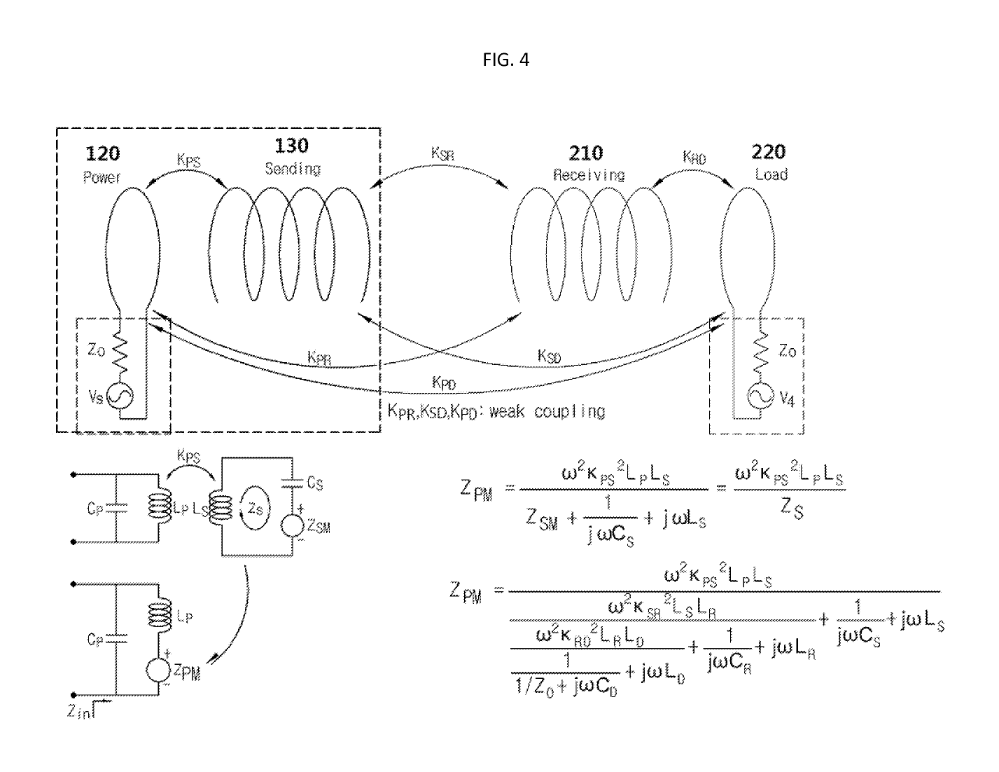

Describing in more detail, FIG. 3 is a diagram illustrating a basic coupling coil structure of the wireless charging control system based on a magnetic resonance type according to the exemplary embodiment of the present invention and FIG. 4 is a diagram schematically illustrating the basic coupling coil structure of FIG. 3 for final analysis.

In the wireless charging control system based on the magnetic resonance type according to the exemplary embodiment of the present invention, a method for changing the input impedance of the power transmitter unit 100 by controlling the capacitance of the receiving resonance circuit or the power receiving circuit of the receiving charger unit 200 will be described with reference to FIGS. 3 and 4, in which the input impedance of the power transmitter unit 100 may be represented by the following Equation 2.

$$\begin{matrix}{Z}_{IN} = ( \frac{1}{j {w}_{0} {C}_{P}} ) // ( j {w}_{0} {L}_{P} + {Z}_{PM} ) \\ = \frac{1}{{jw}_{0} + {C}_{P} + \frac{1}{{jw}_{0} {L}_{P} + {Z}_{PM}}}\end{matrix} \qquad [ Equation 2 ]$$

In the above Equation 2, / / represents a parallel connection.

$${Z}_{PM} = \frac{{w}^{2} {k}_{PS}^{2} {L}_{P} {L}_{S}}{{Z}_{SM} + \frac{1}{{jwC}_{S}} + jwLS}$$

Representing in detail the above Equation 2, the above Equation 2 is represented by the following Equation 3.

$$[ Equation 3 ]$$

$${Z}_{PM} = \frac{{w}^{2} {k}_{PS}^{2} {L}_{P} {L}_{S}}{\frac{{w}^{2} {k}_{SR}^{2} {L}_{S} {L}_{R}}{\frac{{w}^{2} {k}_{RD}^{2} {L}_{R} {L}_{D}}{\frac{1}{\frac{1}{{Z}_{0} + {jwC}_{D}}} + {jwL}_{D}} + {jwC}_{R} + {jwL}_{R}} + \frac{1}{{jwC}_{S}} + {jwL}_{S}}$$

That is, the input impedance of the above Equation 1 is affected by Z_{PM} of the above Equation 3, in which when an inductance L_{P} of the power source coil 120, an inductance L_{S} of the transmitting resonance coil 130, an inductance L_{R} of the receiving resonance coil 210, an inductance L_{D} of the load element coil 220, and capacitance C_{S} of the transmitting resonance capacitor 131 are a fixed value, the Z_{PM} may be changed by the change in capacitance C_{R} of the receiving resonance capacitor 211 or capacitance C_{D} of the load element capacitor 221.

In other words, when the capacitance C_{D} of the load element capacitor 221 is increased, the Z_{PM} is increased. Therefore, an input impedance Z_{IN} of the power transmitter unit 100 is increased.

Further, when the capacitance C_{R} of the receiving resonance capacitor 211 is increased, the Z_{PM} is reduced. Therefore, the input impedance Z_{IN} of the power transmitter unit 100 is reduced.

In addition, when a source impedance of an oscillation voltage of the power transmitter unit 100 is Z0, if V+ and a reflected voltage is represented by V−, a reflection coefficient ρ may be represented by the following Equation 4.

$$ρ = \frac{V -}{V +} = \frac{{Z}_{IN} - {Z}_{0}}{{Z}_{IN} + {Z}_{0}} \qquad [ Equation 4 ]$$

Further, the power transferred to the battery unit may be represented by the following Equation 5.

$$\frac{{W}_{TL}}{{W}_{S}} = 1 - {ρ}^{2} \qquad [ Equation 5 ]$$

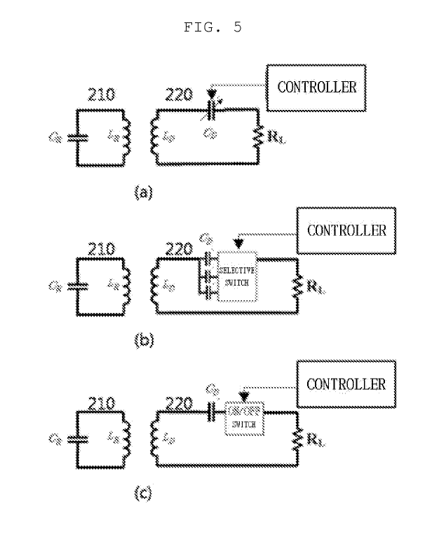

In this case, the controller 230 may be implemented as various exemplary embodiments as illustrated in FIGS. 5A to 5C to change the capacitance of the receiving resonance capacitor 211 or the load element capacitor 221.

The controller 230 of FIG. 5A is configured of one capacitor and may be connected to the receiving resonance coil 210 and the load element coil 220 in parallel or in series.

The controller 230 of FIG. 5B is configured of a plurality of capacitors and thus may be connected to the receiving resonance coil 210 and the load element coil 220 in parallel, in series, and in a combination thereof, and may be used as a selective switch depending on the preset fixed value.

Further, the controller 230 of FIG. 5C is configured of an on/off switch and is connected to the receiving resonance coil 210 or the load element coil 220 and performs pulse time modulation using the on/off switch to convert the load impedance of the receiving resonance circuit or the power receiving circuit into an optimal value at which a current is transferred well or a value at which a current is not transferred, such that the charging current supplied from the power transmitter unit 100 may be controlled with a pulse width or a pulse frequency.

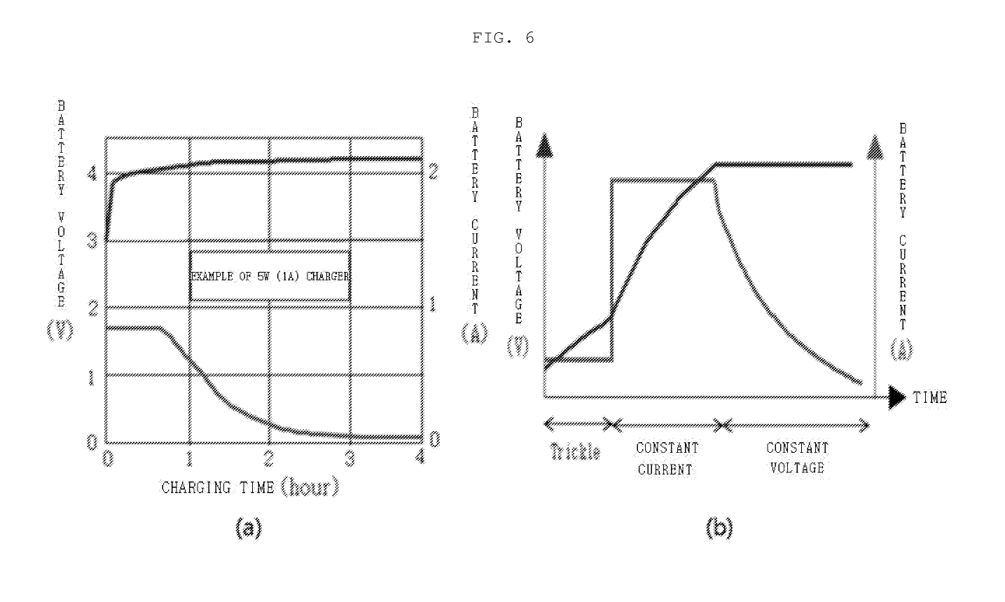

FIGS. 6A and 6B are diagrams illustrating a relationship between a voltage and a current at the time of contactlessly charging using the wireless charging control system based on a magnetic resonance type according to the exemplary embodiment of the present invention.

When the battery voltage is 3V or less, a general battery unit cuts off a system power supply to protect an internal circuit. Therefore, as illustrated in FIG. 6A, a start of charging is represented by 3V. A constant current maximally flows for a predetermined time and a voltage rises. Next, a current drops for a considerable time from a constant voltage state in which a voltage is constant and charging is performed.

FIG. 6B illustrates a relationship between a voltage and a current when the battery unit is fully discharged. In this case, as illustrated in FIG. 6A, when the constant current is directly supplied, since the battery unit is damaged, a trickle current is supplied for a predetermined time to increase a voltage to some degree and then supply a constant current.

To this end, the power transmitter unit 100 may control the constant current which is supplied to the receiving charger unit 200 through a separate operation. In this case, unnecessary power results in a waste of power and is also harmful to the system.

That is, the wireless charging control system based on the magnetic resonance type according to the exemplary embodiment of the present invention may measure the strength of current introduced into the battery unit through the controller 230 and the voltage of the battery unit to appropriately control the charging current supplied to the receiving charger unit 200 through the power transmitter unit 100.

When the receiving resonance capacitor 211 and the load element capacitor 221 are used as the varactor diode, the capacitance may be controlled by controlling the voltage and when the receiving resonance capacitor 211 and the load element capacitor 221 are used as the capacitor having a fixed value and the switch, the capacitance may be controlled by controlling the switch.

Therefore, the charging current value supplied to the receiving charger unit 200 may be controlled by changing the input impedance of the power transmitter unit 100.

That is, when the current amount of the battery unit is reduced, the impedance is changed to be equally reduced to the supplied current amount and after the predetermined time elapses, the strength of the current introduced into the battery unit and the voltage of the battery unit are measured again and thus the charging current value supplied to the receiving charger unit 200 may be continuously controlled appropriately.

As set forth above, according to the exemplary embodiments of the present invention, the wireless charging control system based on a magnetic resonance type does not require the separate transmitter unit and receiver unit to detect the current charging state of the receiving charger unit between the power transmitter unit and the receiving charger unit and changes the transmission output of the power transmitter unit in real time by changing the load impedance of the load element coil using the variable capacitor or the switch to meet the charging state of the battery unit by the receiving charger unit to prevent the unnecessary transmission power while charging, thereby more efficiently and safely performing the wireless charging.

Further, when being buffered of a battery unit, the power transmission from the power transmitter unit stops, such that power may be prevented from wasting and the receiving charger unit and the battery unit may be protected from overcharging.

In addition, since the separate modulator, demodulator, and decoder are not required, the circuit may be simply configured, such that the wireless charging control system based on a magnetic resonance type may be economical and effectively functioned.

As described above, the present invention is described with reference to specific matters such as the detailed components and the limited exemplary embodiments, but is provided to help a general understanding of the present invention. Therefore, the present invention is not limited to the above exemplary embodiments and can be variously changed and modified from the description by a person skilled in the art to which the present invention pertain.

Therefore, the spirit of the present invention should not be limited to the above-described exemplary embodiments, and the following claims as well as all modified equally or equivalently to the claims are intended to fall within the scope and spirit of the invention.

What is claimed is:

1. A wireless charging control system based on a magnetic resonance type, comprising:
an oscillator generating power for contactless charging;
a transmitting oscillation circuit including a power source coil to which the power is input and a power source capacitor connected to the power source coil in parallel to convert a capacitance so as to cause oscillation at a specific frequency;
a power transmitter unit including a transmitting resonance circuit which includes a transmitting resonance coil causing resonance by changing an inductance and a capacitance to be resonated at the same frequency in the transmitting oscillation circuit and a transmitting resonance capacitor connected to the transmitting resonance coil in series;
a receiving resonance coil including a receiving resonance coil receiving electromagnetic waves generated by the power transmitter unit and absorbing input energy by being resonated at the same frequency and a receiving resonance capacitor connected to the receiving resonance coil in series;
a power receiving circuit including a load element coil to receive power of energy stored in the receiving resonance circuit by changing an impedance and a load element capacitor connected to the load element coil in series; and
a receiving charger unit including a controller sensing a strength of current and a charging voltage transferred to a battery unit to change the receiving resonance capacitor or the load element capacitor.

2. The wireless charging control system of claim 1, wherein the receiving resonance capacitor and the load element capacitor are configured of a varactor diode.

3. The wireless charging control system of claim 1, wherein the impedance of the receiving resonance circuit is controlled by controlling a voltage of the receiving resonance capacitor of the receiving charger unit or the impedance of the power receiving circuit is controlled by controlling a voltage of the load element capacitor.

4. The wireless charging control system of claim 3, wherein a charging current amount supplied from the power transmitter unit is controlled by changing an input impedance of the power transmitter unit according to the capacitance of the receiving resonance capacitor or the load element capacitor.

5. The wireless charging control system of claim 3, wherein the controller is configured of one capacitor and is connected to the receiving resonance coil and the load element coil in parallel or in series to change the capacitance of the receiving resonance capacitor or the load element capacitor.

6. The wireless charging control system of claim 3, wherein the controller is configured of a plurality of capacitors, is connected to the receiving resonance coil and the load element coil in parallel, in series, and in a combination thereof to change the capacitance of the receiving resonance capacitor or the load element capacitor, and performs a control as a selective switch according to a preset fixed value.

7. The wireless charging control system of claim 3, wherein the controller is configured of an on/off switch and is connected to the receiving resonance coil or the load element coil to change the capacitance of the receiving resonance capacitor or the load element capacitor and performs pulse time modulation using the on/off switch to convert the load impedance of the receiving resonance circuit or the power receiving circuit into a value at which a current is transferred well or a value at which a current is not transferred, such that the charging current supplied from the power transmitter unit is controlled with a pulse width or a pulse frequency.
